(19) United States
(12) Patent Application Publication
(10) Pub. No.: US 2015/0093494 A1
(43) Pub. Date: Apr. 2, 2015

(54) Bioactive Additive

(71) Applicant: Apipuri, Inc., Santa Clara, CA (US)

(72) Inventors: Konstantine George Chakhunashvili, Tbilisi (GE); David Konstantine Chakhunashvili, Tbilisi (GE); Irakli Artemon Kalandia, Tbilisi (GE)

(73) Assignee: Apipuri, Inc., Santa Clara, CA (US)

(21) Appl. No.: 14/260,283

(22) Filed: Apr. 24, 2014

(30) Foreign Application Priority Data
Oct. 1, 2013 (GE) AU 2013 013249

(51) Int. Cl. A23L 1/076

(52) U.S. Cl. CPC A23L 1/076
USPC 426/648

(57) ABSTRACT

The bioactive additive is made by processing bee pollen. The bioactive additive includes 33% to 40% by weight of bee pollen, 20% to 33% by volume of water, and 33% to 40% by volume of an alcohol such as ethanol. The bioactive additive, when added to products such as bread and bread-like products, enriches the products with amino acids, vitamins, and minerals. The bioactive additive can be used in food production, for example, in the preparation of bread and bread-like products.

### CROSS REFERENCE TO RELATED APPLICATIONS

This application claims priority to and the benefit of non-provisional patent application number AU 2013 013249 titled “Bioactive Additive”, filed in the National Intellectual Property Center of Georgia (Sakpatenti) on Oct. 01, 2013. The specification of the above referenced patent application is incorporated herein by reference in its entirety.

### BACKGROUND

An example of a typical bioactive additive used in food production has the following composition: propolis, a water-alcohol solution, and glycerin. This bioactive additive is used as a tincture. The composition of this bioactive additive is shown in the table below:

| | Dry Ingredients |
|---|---|
| Ingredients | Percentage |
| Propolis Water Extract | 2.5%-7.7% |
| Propolis Alcohol Extract | 0.45%-1.8% |
| Propolis Glycerin Extract | 12.0%-15.0% |
| Ethanol | 0.6%-5.0% |
| Glycerin | 8.5%-11.5% |
| Plant Raw Material Extract | 0.05%-0.5% |
| Water | Fill in till 100% |

### SUMMARY OF THE INVENTION

The bioactive additive disclosed herein is made by processing bee pollen, a natural product. The bioactive additive, when mixed with a product to be enriched, for example, bread, provides a wide spectrum of enrichment with amino acids, vitamins, and minerals. The bioactive additive can be used in the production of various food. However, the best use of the bioactive additive is for enrichment of bread and bread-like products. The bioactive additive is relatively inexpensive to make compared to other enrichments that currently exist in the market.

### DETAILED DESCRIPTION OF THE INVENTION

Disclosed herein is a bioactive additive used in food production. The bioactive additive is made as a water-alcohol solution and a bee pollen suspension. The bioactive additive can be used to enrich milk products, meat and fish conserves, non-alcoholic beverages, bread and bread-like products, macaroni, coffee, cocoa, and other products, with amino acids, vitamins, and minerals. Besides improving biological qualities, the bee pollen suspension improves quality of taste and increases shelf life of a product.

The bee pollen suspension can be used in the production of alcoholic beverages as amino acids present in the bee pollen suspension help an organism in detoxification of alcohol.

The bioactive additive disclosed herein is a suspension of bee pollen and a water-alcohol solution.

The method for making the bioactive additive is as follows:

The first step in making the bioactive additive is to check the moisture content of the bee pollen. If the moisture content of the bee pollen is above 5%, the bee pollen is dried to below 5% moisture content for 10-15 minutes at a temperature of 50-60 degrees Celsius in an electric oven or a drier.

If the moisture content of the bee pollen is below 5%, the drying step is skipped and the process directly proceeds to the grinding step.

In the method disclosed herein, the bee pollen is ground to a mesh size of 80-120, where the particle size is 0.180 millimeters to 0.125 millimeters.

In the next step, a water-ethanol solution is made in a ratio of one part water to one part ethanol, or 1 part water to 2 parts ethanol.

In the next step, the ground bee pollen and the water-ethanol solution is mixed/blended until the suspension is homogenous.

In the final step, the product, that is, the bioactive additive is filled in a polyethylene terephthalate (PET) bottle and the PET bottle is hermetically sealed.

The ratio of the constituents of the bioactive additive can be, for example, 1 liter water: 1 liter ethanol: 1 kg bee pollen, or 0.5 liter water: 1 liter ethanol: 1 kg bee pollen.

The technology of making the bioactive additive is easy.

Propolis contains only 8 amino acids and a low amount of vitamins. Bee pollen, on the other hand, is cheaper, and contains 21 amino acids and a larger spectrum of vitamins and minerals. Valine, leucine, and glycine amino acids found in bee pollen, when mixed with carbohydrates in different food products, for example, bread, etc., create melanoids, which produce a pleasant aroma, have a bactericidal effect, increase shelf life, and act as antioxidants in the food products.

The bioactive additive is a suspension of bee pollen, a dry ingredient.

Ingredient ratio in percentage:

| Ingredient | Percentage |
|---|---|
| Water (Liter) | 20%-33% by volume of the |
| | bioactive additive |
| Ethanol (Liter) | 33%-40% by volume of the |
| | bioactive additive |
| Bee Pollen (Kilogram) | 33%-40% by weight of the |
| | bioactive additive |

Enumerated below are examples of the composition of the bioactive additive:

| | Example 1 | Example 2 | Example 3 |
|---|---|---|---|
| Water | 20% by volume | 33% by volume | 30% by volume |
| | of the bioactive | of the bioactive | of the bioactive |
| | additive (1 Liter) | additive (1 Liter) | additive (0.9 Liter) |
| Ethanol | 40% by volume | 33% by volume | 35% by volume |
| | of the bioactive | of the bioactive | of the bioactive |
| | additive (2 Liters) | additive (1 Liter) | additive (1.05 Liters) |
| Bee Pollen | 40% by weight of | 33% by weight of | 35% by weight of |
| | the bioactive | the bioactive | the bioactive |
| | additive (2 Kgs) | additive (1 Kg) | additive (1.05 Kg) |

### Example 1

A bioactive additive consisting of 20% by volume of water, 40% by volume of ethanol, and 40% by weight of bee pollen is prepared. If the moisture content of the bee pollen is above 5%, the bee pollen is dried at 50° C. to 60° C. for 10 minutes to 15 minutes in an electric oven until the moisture content of the bee pollen is below 5%. The bee pollen is ground to obtain a particle size of 0.180 millimeters to 0.125 millimeters. 40% by weight of the ground bee pollen is then mixed with 20% by volume of water and 40% by volume of ethanol to obtain a homogeneous bee pollen bioactive additive. The bee pollen bioactive additive obtained is filled in a polyethylene terephthalate bottle and hermetically sealed.

### Example 2

A bioactive additive consisting of 33% by volume of water, 33% by volume of ethanol, and 33% by weight of bee pollen is prepared. If the moisture content of the bee pollen is above 5%, the bee pollen is dried at 50° C. to 60° C. for 10 minutes to 15 minutes in an electric oven until the moisture content of the bee pollen is below 5%. The bee pollen is ground to obtain a particle size of 0.180 millimeters to 0.125 millimeters. 33% by weight of the ground bee pollen is then mixed with 33% by volume of water and 33% by volume of ethanol to obtain a homogeneous bee pollen bioactive additive. The bee pollen bioactive additive obtained is filled in a polyethylene terephthalate bottle and hermetically sealed.

### Example 3

A bioactive additive consisting of 30% by volume of water, 35% by volume of ethanol, and 35% by weight of bee pollen is prepared. If the moisture content of the bee pollen is above 5%, the bee pollen is dried at 50° C. to 60° C. for 10 minutes to 15 minutes in an electric oven until the moisture content of the bee pollen is below 5%. The bee pollen is then ground to obtain a particle size of 0.180 millimeters to 0.125 millimeters. 35% by weight of the ground bee pollen is then mixed with 30% by volume of water and 35% by volume of ethanol to obtain a homogeneous bee pollen bioactive additive. The bee pollen bioactive additive obtained is filled in a polyethylene terephthalate bottle and hermetically sealed.

We claim:

1. A bioactive additive consisting of bee pollen, water, and an alcohol.

2. The bioactive additive of claim 1, wherein said bee pollen is 33% to 40% by weight of said bioactive additive.

3. The bioactive additive of claim 1, wherein said water is 20% to 33% by volume of said bioactive additive.

4. The bioactive additive of claim 1, wherein said alcohol is 33% to 40% by volume of said bioactive additive.

5. The bioactive additive of claim 1, wherein said alcohol is ethanol.

6. The bioactive additive of claim 1, wherein said bee pollen enriches a product made therefrom with amino acids, vitamins, and minerals.

7. The bioactive additive of claim 1 configured as a chemical-free processed food additive that enriches a food product with amino acids, vitamins, and minerals.

8. A method for enriching a food product with a bioactive additive made from bee pollen, said method comprising:
preparing said bioactive additive, said bioactive additive consisting of:
33% to 40% by weight of said bee pollen;
20% to 33% by volume of water; and
33% to 40% by volume of an alcohol; and
adding said prepared bioactive additive to said food product to enrich said food product with amino acids, vitamins, and minerals.

9. The method of claim 8, wherein said alcohol is ethanol.

10. A process for preparing a bee pollen bioactive additive, said process comprising:
preparing a water-alcohol solution consisting of 20% to 33% by volume of water and 33% to 40% by volume of an alcohol; and
mixing 33% to 40% by weight of bee pollen with said prepared water-alcohol solution to obtain a homogeneous bee pollen bioactive additive.

11. The process of claim 10, wherein said alcohol is ethanol.

12. The process of claim 10, wherein moisture content of said bee pollen is below 5%.

13. The process of claim 10, further comprising drying said bee pollen at 50° C. to 60° C. for 10 minutes to 15 minutes until moisture content of said bee pollen is below 5%.

14. The process of claim 10, further comprising grinding said bee pollen to a particle size of 0.180 millimeters to 0.125 millimeters.

15. The process of claim 10, wherein said water-alcohol solution consists of said water and said ethanol in a ratio of 1:1 by weight.

16. The process of claim 10, wherein said water-alcohol solution consists of said water and said ethanol in a ratio of 1:2 by weight.

17. The process of claim 10, further comprising filling said homogeneous bee pollen bioactive additive in a container made of polyethylene terephthalate and hermetically sealing said container.
